(19) United States
(12) Patent Application Publication
(10) Pub. No.: US 2009/0139735 A1
(43) Pub. Date: Jun. 4, 2009

(54) Adjustable Escutcheon Assembly For A Sprinkler

(75) Inventors: Shawn G. Orr, Grand Rapids, MI (US); David VanEerden, Middleville, MI (US)

Correspondence Address: HARNESS, DICKEY & PIERCE, P.L.C., P.O. BOX 828, BLOOMFIELD HILLS, MI, 48303, US

(73) Assignee: THE VIKING CORPORATION, Hastings, MI (US)

(21) Appl. No.: 11/948,487

(22) Filed: Nov. 30, 2007

(51) Int. Cl. A62C 2/08; A62C 35/68

(52) U.S. Cl. 169/43; 169/51

(57) ABSTRACT

An adjustable escutcheon assembly as provided for mounting a sprinkler in a sloped ceiling so that the sprinkler can be mounted parallel to the ceiling and with a refined appearance.

### FIELD

The present disclosure relates to an escutcheon assembly for mounting a fire sprinkler and more particularly, to an adjustable escutcheon assembly for mounting a fire sprinkler.

### BACKGROUND AND SUMMARY

The statements in this section merely provide background information related to the present disclosure and may not constitute prior art.

Fire sprinklers are commonly mounted to the ceilings and sidewalls of residential and commercial buildings. Regulations regarding the mounting of fire sprinklers typically require that sprinklers which are installed in the ceiling must be installed with the deflector and/or central axis parallel to the ceiling. When fire sprinklers are installed at the peak of a slope ceiling, there is no escutcheon available to accommodate the sprinkler to be installed as required.

Accordingly, it is desirable to provide an escutcheon that allows a sprinkler to be mounted as required in a sloped ceiling and that has a refined appearance. Accordingly, the present disclosure provides an adjustable escutcheon assembly for a sprinkler. The escutcheon assembly includes an escutcheon member including a receiver body and an escutcheon flange extending from the receiver body. An adapter member is pivotally received in the receiver body and is adapted to receive a sprinkler therein.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a sprinkler mounted to an adjustable escutcheon assembly according to the principles of the present disclosure;

FIG. 2 is a perspective view of the escutcheon assembly with the sprinkler removed;

FIG. 3 is a side view of an escutcheon member according to the principles of the present disclosure;

FIG. 4 is a top plan view of the escutcheon member according to the principles of the present disclosure;

FIG. 5 is a cross-sectional view of an adapter member according to the principles of the present disclosure;

FIG. 6 is a top plan view of the adapter member according to the principles of the present disclosure;

FIG. 7 is a cross-sectional view of an alternative escutcheon member according to the principles of the present disclosure; and

FIG. 8 is a cross-sectional view of an adjustable escutcheon assembly according to a further embodiment of the present disclosure.

### DETAILED DESCRIPTION

The following description is merely exemplary in nature and is not intended to limit the present disclosure, application, or uses. It should be understood that throughout the drawings, corresponding reference numerals indicate like or corresponding parts and features.

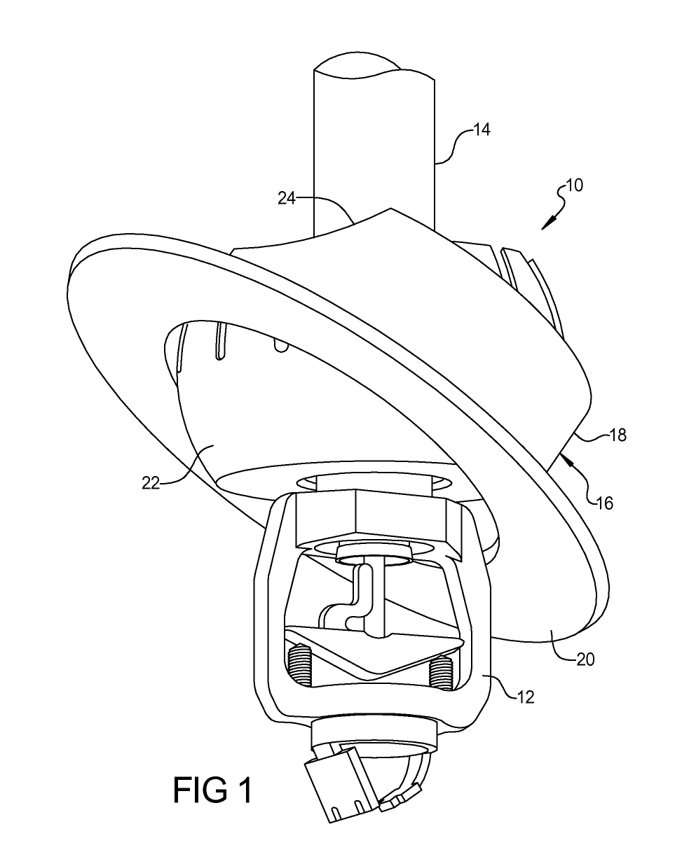

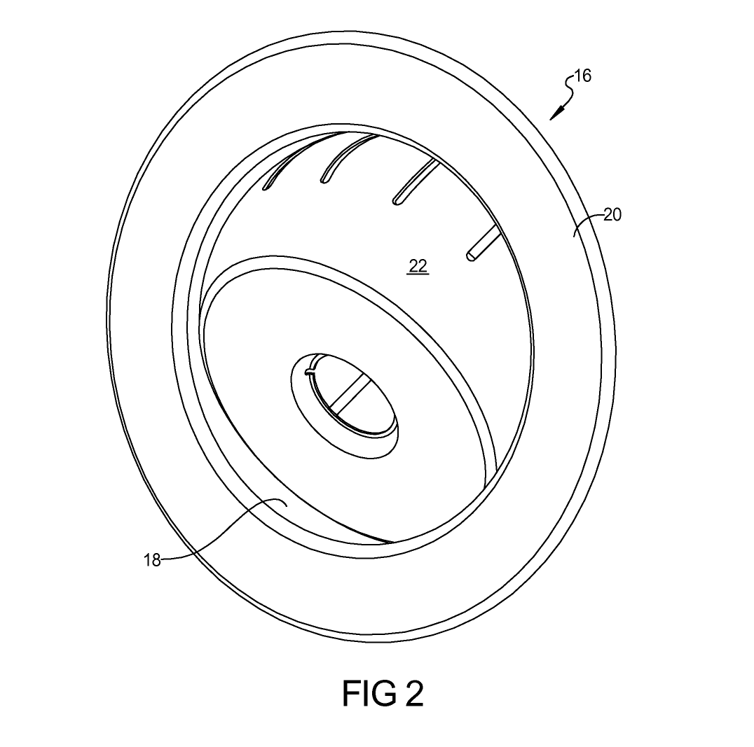

With reference to FIG. 1, an adjustable escutcheon assembly 10 is shown for mounting a sprinkler 12. The sprinkler 12 is attached to a water supply pipe 14. The escutcheon assembly includes an escutcheon member 16 including a receiver body 18 and an escutcheon flange 20 extending from the receiver body 18. An adapter member 22 is pivotally received in the receiver body 18. The adapter member 22 is adapted to receive the sprinkler 12 therein.

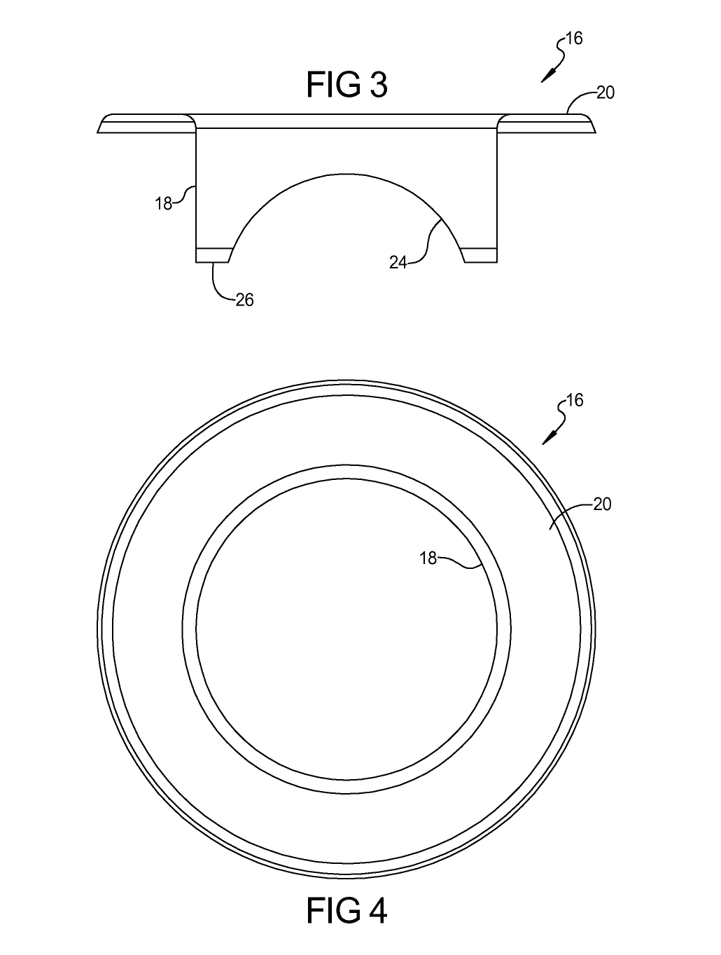

As illustrated in FIG. 1, the receiver body 18 is generally cylindrical and can include one or more cut out regions 24 which prevent interference with the water supply pipe 14 being connected to the sprinkler 12. With reference to FIG. 3, the inboard end of the cylindrical receiver body 18 can include an outwardly tapered edge 26 that facilitates the insertion of the adapter member into the receiver body 18.

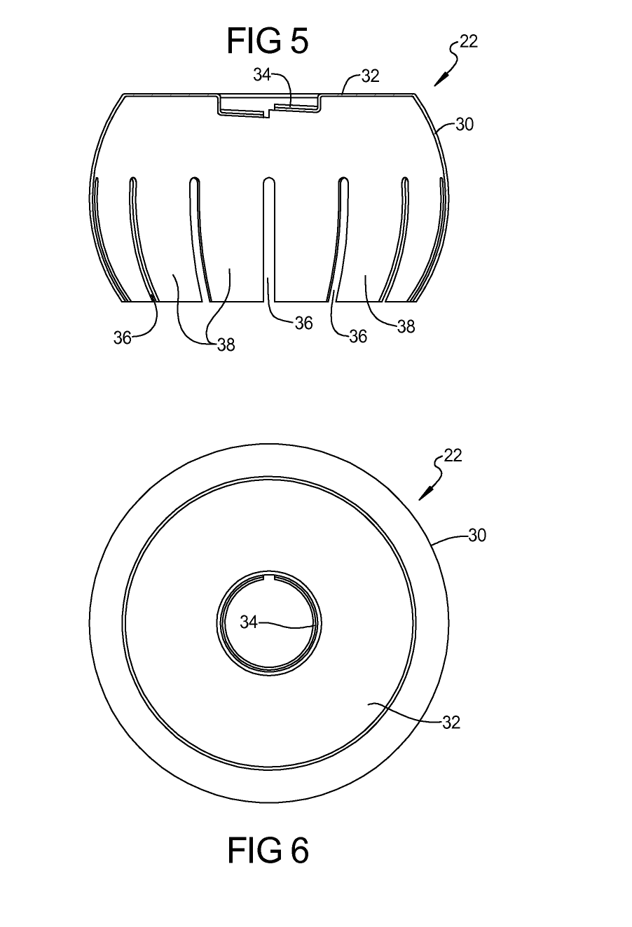

With reference to FIGS. 5 and 6, the adapter member 22 includes a semi-spherical outer surface 30 and a base portion 32 having a threaded aperture 34 for receiving a sprinkler 12 therein. The semi-spherical outer surface 30 includes a plurality of slots 36 that define flexible fingers 38. The flexible fingers 38 facilitate the insertion of the adapter member 22 into the receiver body 18 of the escutcheon member 16.

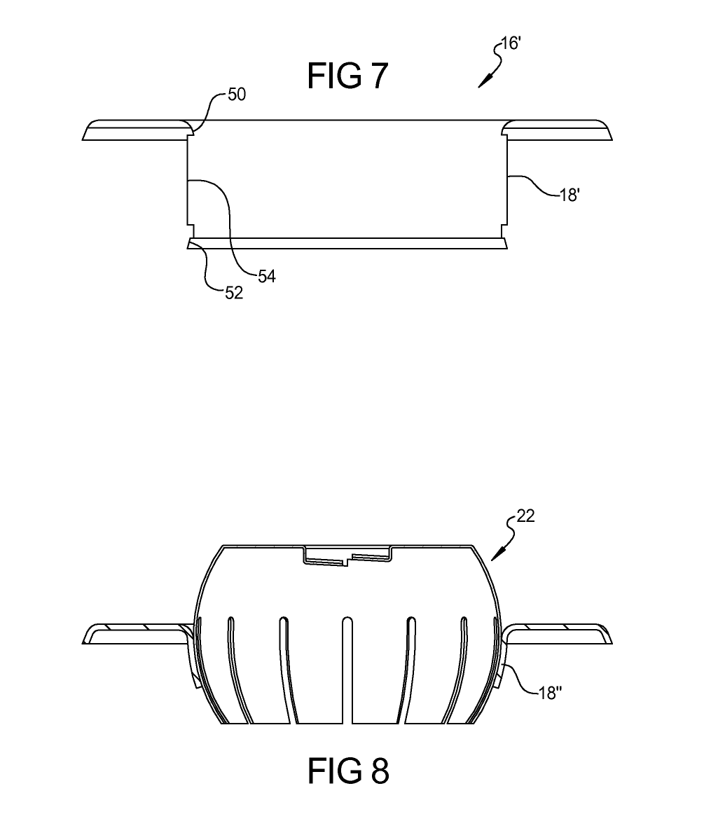

As illustrated in FIG. 7, for larger escutcheon assemblies 16′, the receiver body 18′ does not need to include the recessed portions 24 since the outer diameter of the receiver body 18′ is large enough not to interfere with the attachment of a water supply pipe 14 to the sprinkler 12. As shown in FIG. 7, the cylindrical walls of the receiver body 18′ can include inboard and outboard rib portions 50, 52 each having an inner diameter smaller than an inner diameter of an intermediate portion 54 between the inboard and outboard portions so as to provide a cage-type entrapment for the adapter member 22 once forcibly inserted therein.

With reference to FIG. 8, an alternative embodiment is shown wherein the receiver body 18″ of the escutcheon member 16″ has a semi-spherical shape that is complimentary to the semi-spherical shape of the adapter member 22 so as to provide more secure attachment between the escutcheon member 16″ and the adapter member 22 to prevent movement therebetween during assembly.

During assembly, the escutcheon member 16 would be inserted in an aperture in a finished wall so that the receiver body 18 extends there through and the escutcheon flange 20 is flush with the finished surface. The sprinkler 12 is mounted to the adapter member 22 which is inserted into the receiver body 18 of the escutcheon member 16 and the sprinkler 12 is attached to the water supply line 14.

With the design of the present disclosure, the adjustable escutcheon assembly 10 allows for a sprinkler 12 to be mounted to a sloped ceiling so that the sprinkler is properly oriented. The adjustable escutcheon assembly 10 allows for a refined appearance of the sprinkler 12 which is mounted as required relative to a sloped ceiling.

What is claimed is:

1. An adjustable escutcheon assembly for mounting a sprinkler, comprising:
an escutcheon member including a receiver body and an escutcheon flange extending from said receiver body; and
an adapter member pivotally received in said receiver body, said adapter member being adapted to receive a sprinkler therein.

2. The adjustable escutcheon assembly according to claim 1, wherein said receiver body is generally cylindrical.

3. The adjustable escutcheon assembly according to claim 1, wherein said receiver body is semi-spherical.

4. The adjustable escutcheon assembly according to claim 1, wherein said adapter member includes a threaded aperture for receiving a sprinkler.

5. The adjustable escutcheon assembly according to claim 1, wherein said adapter member is semi-spherical.

6. The adjustable escutcheon assembly according to claim 1, wherein said adapter member is cup-shaped with a base wall adapted to receive a sprinkler and a semi-spherical wall portion pivotally engaged with said escutcheon member.

7. The adjustable escutcheon assembly according to claim 6, wherein said semi-spherical wall of said adapter member includes a plurality of slots.

8. The adjustable escutcheon assembly according to claim 1, wherein said receiver body is generally cylindrical and includes inboard and outboard portions each having an inner diameter smaller than an inner diameter of an intermediate portion between said inboard and outboard portions.

9. The adjustable escutcheon assembly according to claim 8, wherein said adapter member is semi-spherical and has an outer diameter approximately equal to said inner diameter of said intermediate portion of said receiver body.

10. The adjustable escutcheon assembly according to claim 9, wherein said adapter member includes a plurality of slots therein that allow said adapter member to be deformed radially inward so as to be received in said receiver body.

11. An adjustable sprinkler mounting assembly, comprising:
an escutcheon member including a receiver body and an escutcheon flange extending from said receiver body;
an adapter member pivotally received in said receiver body; and
a sprinkler mounted to said adapter member.

12. The adjustable sprinkler mounting assembly according to claim 11, wherein said receiver body is generally cylindrical.

13. The adjustable sprinkler mounting assembly according to claim 11, wherein said receiver body is semi-spherical.

14. The adjustable sprinkler mounting assembly according to claim 11, wherein said adapter member includes a threaded aperture for receiving said sprinkler.

15. The adjustable sprinkler mounting assembly according to claim 11, wherein said adapter member is semi-spherical.

16. The adjustable sprinkler mounting assembly according to claim 11, wherein said adapter member is cup-shaped with a base wall receiving said sprinkler and a semi-spherical wall portion pivotally engaged with said escutcheon member.

17. The adjustable sprinkler mounting assembly according to claim 16, wherein said semi-spherical wall of said adapter member includes a plurality of slots.

18. The adjustable sprinkler mounting assembly according to claim 11, wherein said receiver body is generally cylindrical and includes inboard and outboard portions each having an inner diameter smaller than an inner diameter of an intermediate portion between said inboard and outboard portions.

19. The adjustable sprinkler mounting assembly according to claim 18, wherein said adapter member is semi-spherical and has an outer diameter approximately equal or larger than said inner diameter of said intermediate portion of said receiver body.

20. The adjustable sprinkler mounting assembly according to claim 19, wherein said adapter member includes a plurality of slots therein that allow said adapter member to be deformed radially inward so as to be received in said receiver body.

21. A method of installing a fire sprinkler, comprising:
mounting a sprinkler to an adapter member;
installing an escutcheon in an aperture in one of a wall or a ceiling surface, said escutcheon including a receiver body extending from an escutcheon flange;
inserting said adapter member in said receiver body of said escutcheon, said adapter member being pivotable relative to said receiver body; and
connecting a water supply line to said fire sprinkler.

22. The method according to claim 21, wherein said adapter member is semi-spherical.
